(19) United States
(12) Patent Application Publication
(10) Pub. No.: US 2024/0112418 A1
(43) Pub. Date: Apr. 4, 2024

(54) XR World Build Capture and Playback Engine

(71) Applicant: Meta Platforms Technologies, LLC, Menlo Park, CA (US)

(72) Inventors: Sarah BARRICK, Cupertino, CA (US); Rachel CROSS, Foster City, CA (US); Patricia DOOLEY, Bothell, WA (US); Jean CHIN, Menlo Park, CA (US); Katerina VASILIOU, Seattle, WA (US); Tiffany MADRUGA, New York, NY (US)

(73) Assignee: Meta Platforms Technologies, LLC, Menlo Park, CA (US)

(21) Appl. No.: 18/068,975

(22) Filed: Dec. 20, 2022

Related U.S. Application Data
(60) Provisional application No. 63/377,571, filed on Sep. 29, 2022.

(51) Int. Cl. G06T 19/00; G06F 3/0482; G06T 19/20

(52) U.S. Cl. CPC G06T 19/006; G06F 3/0482; G06T 19/20; G06T 2219/2012

(57) ABSTRACT

Aspects of the present disclosure are directed to systems for capturing, recording, and playing back steps for building objects and structures in an artificial reality (XR) world. A teacher or creator can initiate a capture context within a build mode of an XR application, during which steps (and potentially other metadata) of a building process are recorded and stored. A XR world building engine can generate an interactive replay of the recorded building process that allows another user to view the building process within an XR environment at the user's preferred pace and/or from different perspectives. In some implementations, the XR world building engine can generate a replay of the teacher's or creator's avatar performing the building process, such that the user can view the building process from a third person perspective and perform the same steps to learn how to build objects and structures in an XR world.

### CROSS REFERENCE TO RELATED APPLICATIONS

This application claims priority to U.S. Provisional Patent Application No. 63/380,602, titled “XR World Build Capture and Playback Engine,” with Attorney Docket No. 3589-0169PV01, which is herein incorporated by reference in its entirety

### BACKGROUND

Users interacting with artificial reality (XR) devices can view content in an artificial reality environment that includes real-world objects and/or two-dimensional (2D) and/or three-dimensional (3D) virtual objects. For example, the artificial reality environment can be a virtual environment depicted by a virtual reality (VR) device showing a set of virtual objects. As another example, the artificial reality environment can be a mixed reality environment with real-world objects and virtual objects supplemented over the real-world objects. A user can view the objects in the artificial reality environment and modify content in the artificial reality environment.

While XR systems can provide intuitive ways of viewing, navigating through, and interacting with objects in an XR environment, there exists a learning curve for effectively using tools for creating new content or modifying existing content within that XR environment. Creating new structures can involve generating 2D surfaces, modifying 3D objects, moving those objects around (e.g., aligned with other objects, attached to other objects, etc.), configuring the properties of those objects, and/or a variety of other steps. Users wishing to learn XR world building tools may resort to reading through documentation and/or watching tutorial videos outside of the XR environment, later returning to the XR world to attempt to reproduce those steps from memory. Such traditional learning processes can be cumbersome and frustrating to users, making it difficult for them to learn how to use build tools in an XR world.

### BRIEF DESCRIPTION OF THE DRAWINGS

FIG. 1 is a conceptual diagram illustrating an example user interface (UI) of a XR world build playback application.

FIG. 2 is a conceptual diagram illustrating an example XR world build playback implementation in which a ghost of a creator's avatar is rendered alongside the user.

FIG. 3 is a flow diagram illustrating a process used in some implementations for capturing a creator's XR world build actions.

FIG. 4 is a flow diagram illustrating a process used in some implementations for playing back a creator's XR world build actions to a user.

FIG. 5 is a block diagram illustrating an overview of devices on which some implementations of the present technology can operate.

FIG. 6A is a wire diagram illustrating a virtual reality headset which can be used in some implementations of the present technology.

FIG. 6B is a wire diagram illustrating a mixed reality headset which can be used in some implementations of the present technology.

FIG. 6C is a wire diagram illustrating controllers which, in some implementations, a user can hold in one or both hands to interact with an artificial reality environment.

FIG. 7 is a block diagram illustrating an overview of an environment in which some implementations of the present technology can operate.

### DETAILED DESCRIPTION

A unique aspect of artificial reality (XR) lies in the ability to create and explore expansive and immersive virtual worlds—both renditions of real-world locations, and new fanciful worlds that exist only within the metaverse. Many artists, architects, and other world builders that discover XR want to build their own virtual worlds to create interactive experiences, games, art expositions, and a variety of other experiences. However, building interactive objects and environments in an XR world can require skills and knowledge about a specific XR universe's building tools, leading many users to consult documentation, video tutorials, and other resources outside of the XR environment to learn how to build new and exciting objects and environments in their XR world.

Creators previously needed to purchase additional hardware (e.g., video capture cards) or software (e.g., screen recorders) to record video tutorials or other guides for creating new objects or environments in an XR world. For example, a creator might use video capture software and/or hardware to record a video of themselves building a particular object or structure in an XR world and subsequently upload that video to a video sharing website as educational content for other users to learn from. Accordingly, the typical methods for generating new educational content for building XR worlds involved additional cost to the creator and the use of multiple, disconnected systems.

For users wishing to access educational content, the process might involve the user removing a VR headset, going to their computer or mobile device, looking up some information, storing the steps in their short-term memory, putting the VR headset back on, and later attempting to recall the steps back in the XR environment. Such a cumbersome process can make learning slow and challenging for users. Moreover, unlike learning how to use computer software or do other real-world tasks, learning how to use XR world build tools has previously involved switching in and out of the XR environment, which can be jarring to users and make the process challenging and unintuitive.

Aspects of the present disclosure provide systems and methods to enable the capture and playback of actions performed in an XR environment by a creator, instructor, or other user. In an example embodiment, a creator in an XR environment can trigger or initiate a capture mode with an XR build capture and playback engine (hereinafter “XR world build engine” or “engine”). The engine can monitor the creator's movements, menu invocations, menu selections, object manipulation, object configuration, and/or any other recordable action. When the creator performs a recordable action, the engine can log that action (along with metadata, audio recording, annotations, and/or any other associated information) as a part of the capture session. Some inputs by the creator may be specifically disregarded by the engine (i.e., actions not related to the creation of the object or structure in the XR world, similar to parametric modeling in computer aided design systems). Once the creator has finished building the object or structure, the creator can instruct the engine to exit capture mode and end the session. Each action can be stored as data in an appropriate format (e.g., JSON, XML, blobs, binary, etc.) in the order that they were performed, such that they can serve as a series of instructions (i.e., similar to a macro or script) that can reproduce the steps the creator performed to create the object or structure.

In some implementations, the creator can edit one or more of the recorded actions after ending the capture session. For instance, the creator can add text and/or audio annotations linked to a corresponding action or sequence of actions (e.g., to provide supplementary explanations as to the significance of the actions performed). In some cases, the creator may have performed a particular action that they wish to parameterize or otherwise make modifiable by users upon playback of the build record, such as selecting a particular style, linking an object to a specific URL or blockchain address, or some other action that the creator foresees users wishing to modify. The engine can allow one or more aspects of an action to be user-adjustable during playback, thereby allowing the user to personalize their learning experience and gain a deeper understanding of the XR world build tools.

The engine can store the recorded actions, annotations, and metadata as a build record on a server. In some implementations, the build record may be made accessible to other users via a sharing service accessible within the XR world. For instance, a user might want to learn how to build a transparent window for their house in their XR world, and can open a sharing service within the XR application to discover tutorials and other build records that can be used to play back one or more techniques for building windows with the XR world building tools.

When a user opens a particular build record, the engine can obtain the data from the server, along with any associated metadata and/or annotations. The engine can, in some implementations, interpret the build record or otherwise convert portions of the build record into instructions (e.g., a script, SDK or API function calls, etc.). Once the build record has been processed, the engine can place the user in an XR world and provide them with playback tools to play back the sequence of recorded actions. In some implementations, each action may be performed automatically by the user's avatar, such that the user experiences the actions from a first-person perspective. The engine can allow the user to play back each step at a desired speed, pause the playback, jump backwards or forwards to a different step, and/or otherwise step through the build record at their own pace. For instance, the user can allow the engine to take control of their avatar to perform a step (e.g., resize a surface or object, snap one object to another, etc.), step backwards to “undo” that step, and then repeat the process manually to do it themselves. In this manner, the engine can provide an interactive and immersive learning experience, which does not involve the user exiting the XR world and use a different device to read documentation or watch a tutorial video.

In some implementations, the user can switch from a first-person perspective to a different perspective (e.g., third person view, a free-floating camera view, etc.). For instance, if an object manipulation is not entirely visible from the first-person perspective, the user can “detach” from the avatar and move to a different perspective to better examine the effects of a given action. As a specific example, an action for adding indoor lighting elements to the user's house may create an effect visible from outside the house, and the user may wish to see the visual effect the lights have from different angles or from outside the house. The engine can allow the user to view the performance of the actions and/or the results of those actions from different perspectives to facilitate a better understanding of the build process and/or the XR world.

In some implementations, the user can configure the engine to play back the build record on a different “ghost” avatar—which is separate from the user's avatar—to enable the user to observe the build process from an external viewpoint. The engine can provide inputs that allow the user to control the “ghost” or teacher avatar in a manner similar to the above, first-person avatar playback example. However, by having a separate teacher avatar perform the actions, the user can observe and repeat those actions separately, in a manner similar to attending a class in the real world (e.g., watching an instructor perform a task and attempting to replicate that task independently). In these implementations, the user may be placed in a sandboxed environment, such that the entire process of following along with an instructor does not affect the user's XR world.

In cases where the build record includes parameterized steps, the user may be prompted during playback of the build script to configure the parameterized actions (e.g., either at the beginning of playback, or upon playback of the parameterized action). For instance, the engine can provide a menu of options to the user and/or request a manual input from the user to personalize the build record to the user. Such parameterized actions may be desirable if the user wants to use the resulting object or structure in their own XR world without having to repeat the steps a second time. For example, if the user launches a build record to learn how to add their non-fungible token (NFT) art to their XR world, the user may be able to configure the action parameter for linking to their NFT (as opposed to whichever NFT was linked to by the creator of the build record). Then, when playback is finished, the engine can store the completed object to allow the user to easily add the pre-built NFT object to their XR world at a later time without having to repeat the actions in the build record again.

In some implementations, a build record may be provided or sold in a marketplace as an automated script for generating non-standard objects or structures in an XR world. Creators might develop custom staircase designs, unique pieces of furniture, interactive artwork installments, and/or other custom objects or structures that do not exist in a default or stock library of objects or structures. In some cases, creators may wish to monetize their custom designs by selling them in a marketplace to other users, who can purchase build records for educational purposes and/or to quickly replicate a design created by another user (i.e., similar to a UI design kit for frontend UI libraries). Such build records may be parameterized to allow customers to configure the designs to suit their preferences before running the build record through the engine to generate the custom object or structure.

Across the various implementations contemplated herein, the XR world build capture and playback engine can facilitate the recording and playback of build actions from creators, all without having to leave the XR environment. In this manner, users can engage in more “hands-on” learning within the XR environment, as opposed to leaving the XR environment and referring to other sources outside of their XR world. By capturing the actions of creators as data (rather than a generic video), the actions taken to build a custom object or structure can be played back by the XR application itself, thereby enabling dynamic, interactive tutorials that users can engage with intuitively and in an immersive manner. In addition, capturing build actions as data rather than as a video enables the parameterization of certain build actions, thereby allowing the same build record to be used to generate different objects and/or structures. Over time, creators can develop a variety of new objects and structures, expanding the available resources for new users to learn how to build fun and interactive XR worlds of their own.

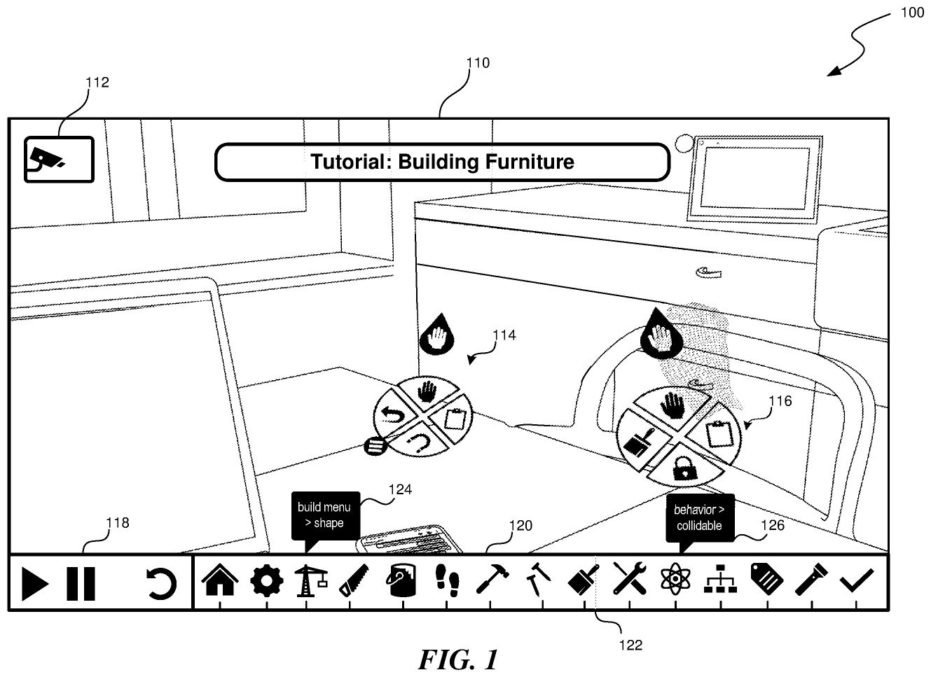

FIG. 1 is a conceptual diagram 100 illustrating an example user interface (UI) of a XR world build playback application. More particularly, FIG. 1 illustrates an example playback mode of a recording of furniture building that includes captured actions previously performed by a creator. The UI includes a main window 110 in which the user's avatar's first-person perspective is rendered. In this example, menu and cursor elements 114 and 116 (corresponding the user's left and right hands, respectively) are shown within the main window 110. The UI also includes a playback controls section 118, which can include a combination of buttons and inputs for controlling the playback of the build recording, the speed of the playback, and/or provide shortcuts to jump backwards or forwards across actions within the build record.

In addition, the UI includes a build actions timeline 120, which includes an ordered sequence of icons corresponding to different actions performed in the course of the captured build process. In this example, the current playback location may be denoted by a tick 122 or other graphical element, indicating to the user which step they are viewing in the build process. One or more of the actions in the build record may be associated with annotations captured by or manually recorded by the creator of the build record—such as annotations 124 and 126—which can provide additional information about the choice to perform that action, more detailed explanations about how those actions work, and/or other relevant information to the user.

In some cases, the UI can also include an option to change the perspective shown in the main window 110, such as perspective button 112. For example, pressing button 112 may cycle through two or more different perspectives (e.g., first person, third person, free camera, etc.).

In some implementations, the user can pause playback and freely control the avatar to interact with the XR environment, access menus, activate functions, and/or otherwise engage in whatever actions the user desires (e.g., repeating the steps of the build process to learn how to use the build tools). The user can, in some cases, alter steps of the build process by pausing playback, performing their own action(s), and then resuming playback thereafter. In this manner, unlike reading documentation or watching a video guide, the user can easily transition between viewing an action and doing the action themselves, all without having to leave the XR environment.

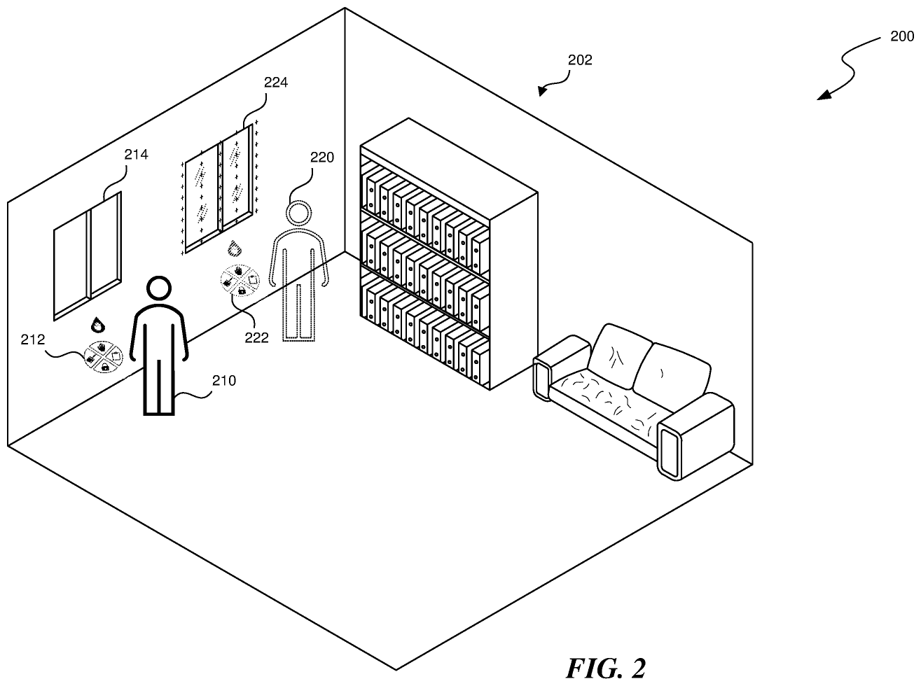

FIG. 2 is a conceptual diagram 200 illustrating an example XR world build playback implementation in which a ghost of a creator's avatar 220 is rendered alongside the user's avatar 210. More particularly, the user is following along a build record that guides the user through the process of creating customized, realistic windows that can be added to their house in their XR world. In contrast with the example shown in FIG. 1, the user has chosen to instantiate the creator's avatar 220 as separately from their own avatar 210, so that they can watch the creator's avatar 220 step through the process of creating custom windows and then independently repeat those steps to make the window objects themselves. The creator's avatar 220 has its own menu palette 222, which is independent and separate from the menu palette 212 of the user's avatar 210.

XR environment 202 may be a sandbox environment which is unrelated to the user's XR world. As shown in FIG. 2, the user is observing the creator's avatar 220 add a shiny reflection aesthetic to the glass of the creator's window 224—which the user may subsequently attempt to add to their own window 214 after learning how to do so. Thus, the user can watch the creator's avatar 220 in a similar manner as a student observing a teacher perform a task in the real world, which may be a more intuitive or natural learning experience for some users (compared to having the user's own avatar be controlled by the engine).

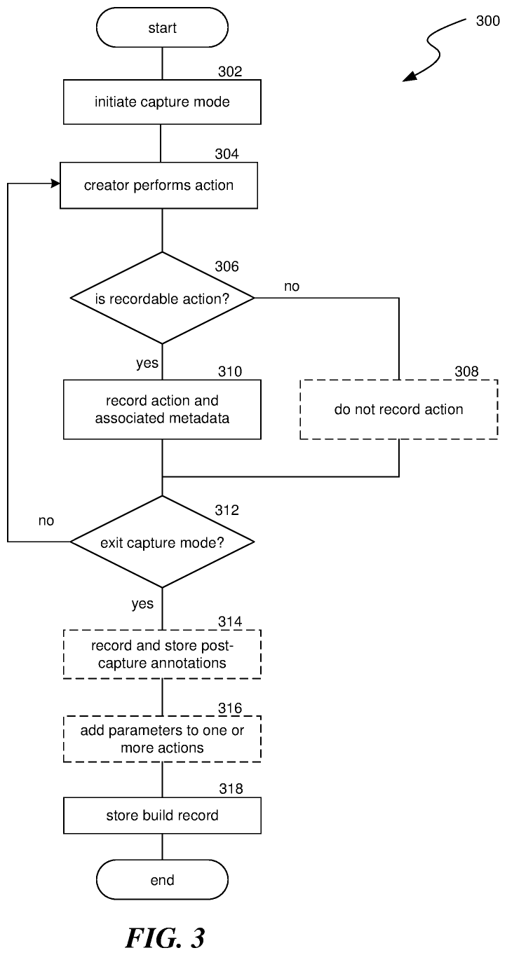

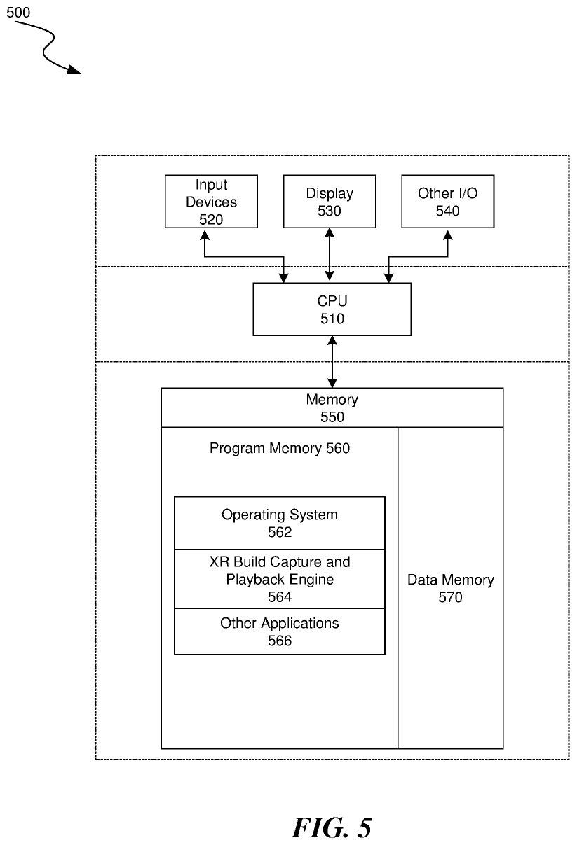

FIG. 3 is a flow diagram illustrating a process 300 used in some implementations for capturing a creator's XR world build actions. In some implementations, process 300 can be performed as a response to a creator's request to begin capturing steps of a build process. Process 300 can be performed by, for example, XR build capture and playback engine 564 of FIG. 5, either on a server or combination of servers over a network, or locally on a user system or device, i.e., an XR device (e.g., a head-mounted display) or 2D device, such as a computer or other display or processing device. In some implementations, some steps of process 300 can be performed on a server, while other steps of process 300 can be performed locally on a user device. Although illustrated as having only one iteration, it is contemplated that process 300 can be performed multiple times, repeatedly, consecutively, concurrently, in parallel, etc., as requests to capture and store build records on a variety of devices associated with a respective variety of creators. Some steps of process 300 can described as recording data (e.g., actions, metadata, annotations, etc.), some of which may be performed client side within an XR application, while other steps (e.g., storing the build record at block 318) might be performed server side within an XR universe server.

At block 302, process 300 initiates a capture mode. For example, a creator may invoke a menu option, press a button, or otherwise request to start capturing build actions as a part of a tutorial process and/or to add to a marketplace of custom object designs. The capture mode may be performed within a separate sandboxed XR environment specifically instantiated for capturing build processes, or may be invoked within the creator's XR world, depending on the particular implementation.

At block 304, process 300 captures the creator performing an action. For instance, if the creator opens a new menu, creates a new surface, shape, or object, modifies a surface, shape, or object, adds or modifies properties to surface, shape, or object (e.g., collidability, visibility, gravity, physical properties, deep links, etc.), adds a script or linked actions to an object (e.g., upon interaction, proximity triggered, etc.), and/or performs any other action that meaningfully changes an object's properties—process 300 can capture that action with sufficient fidelity to be able to reproduce that action automatically during playback.

At block 306, process 300 determines whether the action performed by the creator was a recordable action. In some cases, an action performed by a creator may not meaningfully alter an objects properties, such as moving the creator's avatar, looking around, clicking in and out of a menu without selecting a particular menu item, and/or a variety of other actions that do not affect the object or XR environment. Depending on the context and its relevance to prior and future actions, process 300 may determine that the action is recordable or non-recordable. This determination may be based on a predetermined list of recordable actions, based on a parametric modeling paradigm (e.g., did the action change an object's properties?), and/or using other suitable heuristics. If the action was not a recordable action, process 300 may proceed to block 308, where the action is ignored or otherwise not recorded. Alternatively, if the action was a recordable action, process 300 proceeds to block 310, where process 300 records the action and its associated metadata, if any (e.g., annotations, audio segments, etc.).

At block 312, process 300 determines whether to exit capture mode. For example, if the creator might manually select to exit capture mode when the build process is complete. If process 300 determines to exit capture mode, process 300 proceeds to block 314, where process 300 may record and store post-capture annotations. For example, the creator may end the capture session and proceed to add additional text and/or audio explanations for certain actions. The creator may choose not to add any additional annotations after ending the capture session.

At block 316, process 300 may add parameters to one or more of the recorded actions. For instance, the creator might end the capture session and modify certain recorded actions that the creator wants to be user-configurable (e.g., material selection, colors, styling, etc.). The engine can provide tools to the creator to convert a hard-coded action into a parameterized one (e.g., on actions where a particular option was selected from among a list of possible options).

At block 318, process 300 stores the build record. In some embodiments, process 300 (executing on an VR device, for instance) transmits a copy of the build record to a server. The server may store a copy of the record in a file storage system and/or a database, which may be accessed by other services and/or marketplaces to be shared or made discoverable to other users.

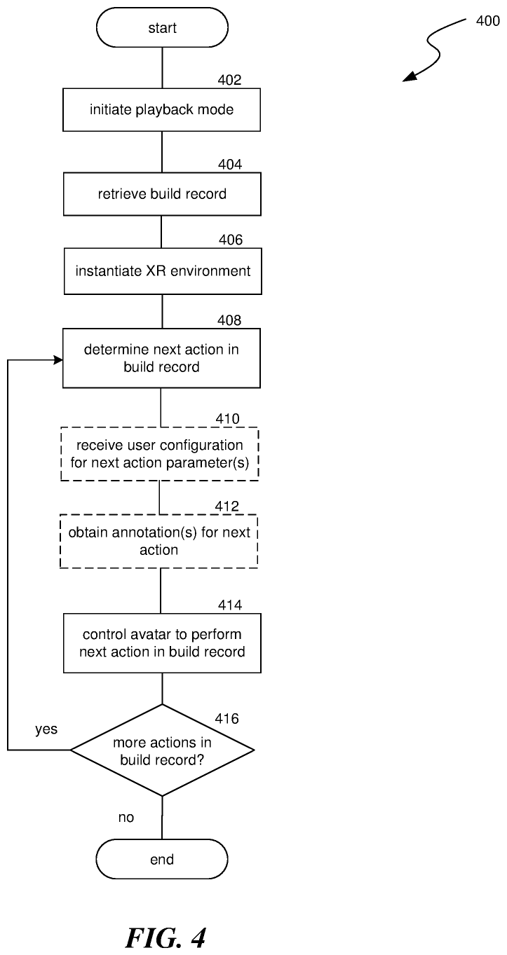

FIG. 4 is a flow diagram illustrating a process used in some implementations for playing back a creator's XR world build actions to a user. In some implementations, process 400 can be performed as a response to a user's request to begin playing back steps of a build process. Process 400 can be performed by, for example, XR build capture and playback engine 564 of FIG. 5, either on a server or combination of servers over a network, or locally on a user system or device, i.e., an XR device (e.g., a head-mounted display) or 2D device, such as a computer or other display or processing device. In some implementations, some steps of process 400 can be performed on a server, while other steps of process 400 can be performed locally on a user device. Although illustrated as having only one iteration, it is contemplated that process 400 can be performed multiple times, repeatedly, consecutively, concurrently, in parallel, etc., such as when a user repeats the playback of certain steps in a build process, reviews a build process multiple times, plays back steps in a different order than they were recorded, etc.

At block 402, process 400 initiates a playback mode. For example, a user may select a particular build record from a repository, marketplace, or other sharing service within an XR application which launches a playback mode of an XR world build capture and playback engine. An XR application may instantiate an XR environment, load one or more avatars, instantiate playback and viewing controls, and then wait for the user to start playback of the build record.

At block 404, process 400 retrieves a stored build record. Block 404 may be performed before, during, or after block 402. For instance, upon receiving a selection to play back a build record, process 400 might asynchronously retrieve the build record while also initializing an XR environment at block 406, and instantiating the playback controls at block 402. At block 406, process 400 instantiates an XR environment. Upon completed 402-406, a user's XR environment may render similar UI elements as those shown in FIG. 1.

At block 408, process 400 determines the next action in the retrieved build record. Immediately after initialization, block 408 may determine that the next action is the first action in the build process. If the user starts normal playback, process 400 can iteratively process the next action, cause an avatar to perform the action (possibly modified based on user-provided parameters), process the next action, and so on.

At block 410, process 400 may receive a user configuration for the next action parameter(s). In some implementations, the user might be prompted to configure parameters of a particular action before it is processed. In other cases, the user may configure the parameters in advance, and process 400 retrieves the previously-captured user parameter preferences at block 410. Regardless, block 410 may only be performed when an action is parameterized.

At block 412, process 400 obtains annotation(s) for the next action, if any. For example, a voiceover or audio recording may be retrieved and played in parallel with the action, so as to emulate an explainer video or tutorial.

At block 414, process 400 controls an avatar to perform the next action in the build record. In some cases, process 400 can take control of the user's avatar to perform the next action in the build record. In other cases, process 400 can control a creator or “ghost” avatar to perform the next action in the build record. Causing an avatar to perform an action may itself involve a sequence of actions. For example, the process of resizing an object may involve selecting a vertex of the object, pinching that vertex, dragging the vertex while pinching, and then releasing the pinch. Thus, it will be appreciated that the term “action” may encompass multiple sub-operations which, when performed sequentially or in concert, results in a macro-level action. The engine may capture individual operations, identify a pattern or particular sequence of operations as representing a macro-level action, and then label that macro-level action as a single action even though performing that action involves multiple sub-steps.

At block 416, process 400 determines whether there are more actions in the build record. If there are more actions in the build record, process 400 returns to block 408. However, if there are no more actions in the build record, process 400 may complete. In some cases, process 400 may remain in playback mode even if no more actions remain in the build record (i.e., playback has finished because it reached the end of the captured build process). But process 400 may not exit playback mode until the user explicitly ends the playback session, such that the user can step back through the actions, review a particular action in the build record again, play back the entire build process again from the beginning, etc.). Thus, it will be appreciated that the end of process 400 does not necessarily mean that the engine exits playback mode.

FIG. 5 is a block diagram illustrating an overview of devices on which some implementations of the disclosed technology can operate. The devices can comprise hardware components of a device 500 that captures and plays back a build process for an XR object or structure. Device 500 can include one or more input devices 520 that provide input to the Processor(s) 510 (e.g., CPU(s), GPU(s), HPU(s), etc.), notifying it of actions. The actions can be mediated by a hardware controller that interprets the signals received from the input device and communicates the information to the processors 510 using a communication protocol. Input devices 520 include, for example, a mouse, a keyboard, a touchscreen, an infrared sensor, a touchpad, a wearable input device, a camera- or image-based input device, a microphone, or other user input devices.

Processors 510 can be a single processing unit or multiple processing units in a device or distributed across multiple devices. Processors 510 can be coupled to other hardware devices, for example, with the use of a bus, such as a PCI bus or SCSI bus. The processors 510 can communicate with a hardware controller for devices, such as for a display 530. Display 530 can be used to display text and graphics. In some implementations, display 530 provides graphical and textual visual feedback to a user. In some implementations, display 530 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 540 can also be coupled to the processor, such as a network card, video card, audio card, USB, firewire or other external device, camera, printer, speakers, CD-ROM drive, DVD drive, disk drive, or Blu-Ray device.

In some implementations, the device 500 also includes a communication device capable of communicating wirelessly or wire-based with a network node. The communication device can communicate with another device or a server through a network using, for example, TCP/IP protocols. Device 500 can utilize the communication device to distribute operations across multiple network devices.

The processors 510 can have access to a memory 550 in a device or distributed across multiple devices. A memory includes one or more of various hardware devices for volatile and non-volatile storage, and can include both read-only and writable memory. For example, a memory can comprise random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 550 can include program memory 560 that stores programs and software, such as an operating system 562, XR build capture and playback engine 564, and other application programs 566. Memory 550 can also include data memory 570, e.g., build actions, parameters, annotations, audio segments, video, configuration data, settings, user options or preferences, etc., which can be provided to the program memory 560 or any element of the device 500.

Some implementations can be operational with numerous other computing system environments or configurations. Examples of computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

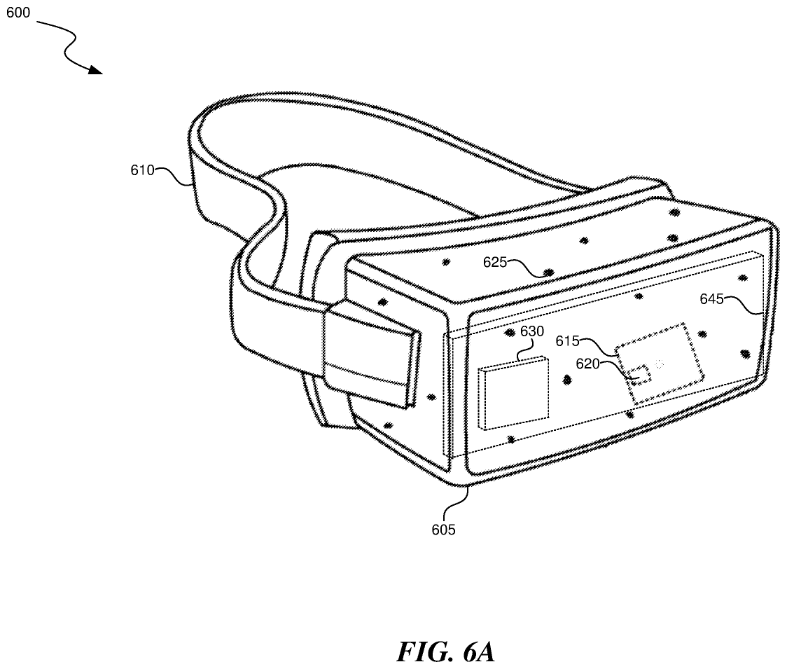

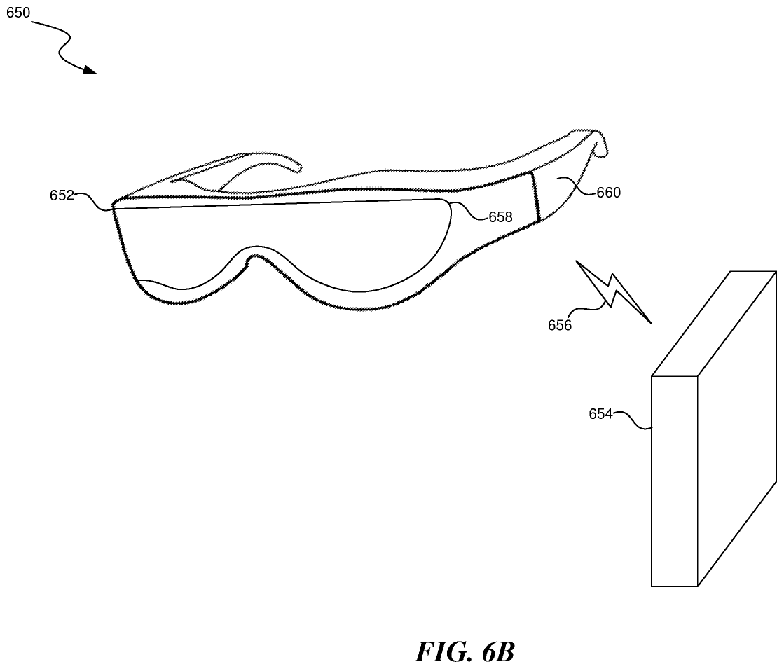

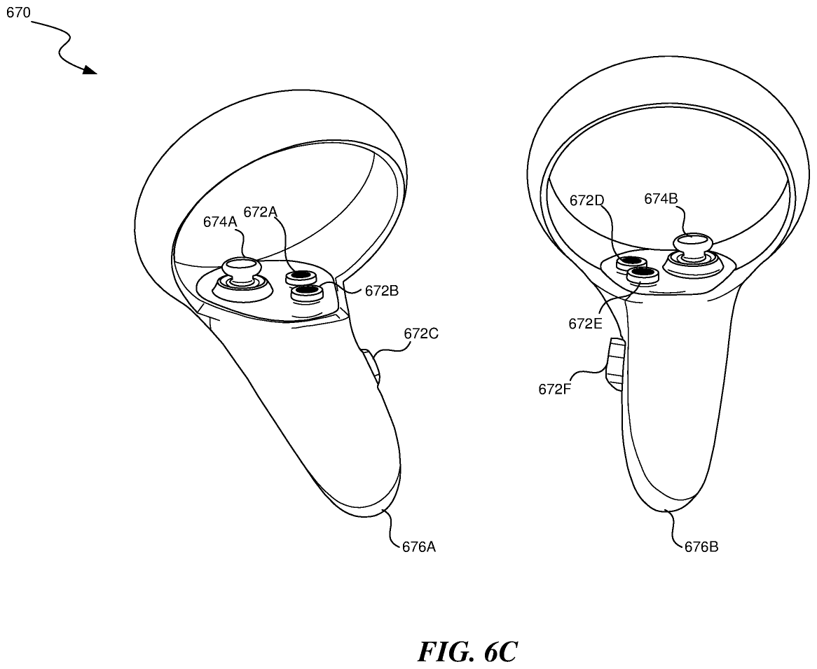

FIG. 6A is a wire diagram of a virtual reality head-mounted display (HMD) 600, in accordance with some embodiments. The HMD 600 includes a front rigid body 605 and a band 610. The front rigid body 605 includes one or more electronic display elements of an electronic display 645, an inertial motion unit (IMU) 615, one or more position sensors 620, locators 625, and one or more compute units 630. The position sensors 620, the IMU 615, and compute units 630 may be internal to the HMD 600 and may not be visible to the user. In various implementations, the IMU 615, position sensors 620, and locators 625 can track movement and location of the HMD 600 in the real world and in an artificial reality environment in three degrees of freedom (3DoF) or six degrees of freedom (6DoF). For example, the locators 625 can emit infrared light beams which create light points on real objects around the HMD 600. As another example, the IMU 615 can include e.g., one or more accelerometers, gyroscopes, magnetometers, other non-camera-based position, force, or orientation sensors, or combinations thereof. One or more cameras (not shown) integrated with the HMD 600 can detect the light points. Compute units 630 in the HMD 600 can use the detected light points to extrapolate position and movement of the HMD 600 as well as to identify the shape and position of the real objects surrounding the HMD 600.

The electronic display 645 can be integrated with the front rigid body 605 and can provide image light to a user as dictated by the compute units 630. In various embodiments, the electronic display 645 can be a single electronic display or multiple electronic displays (e.g., a display for each user eye). Examples of the electronic display 645 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 600 can be coupled to a core processing component such as a personal computer (PC) (not shown) and/or one or more external sensors (not shown). The external sensors can monitor the HMD 600 (e.g., via light emitted from the HMD 600) which the PC can use, in combination with output from the IMU 615 and position sensors 620, to determine the location and movement of the HMD 600.

FIG. 6B is a wire diagram of a mixed reality HMD system 650 which includes a mixed reality HMD 652 and a core processing component 654. The mixed reality HMD 652 and the core processing component 654 can communicate via a wireless connection (e.g., a 60 GHz link) as indicated by link 656. In other implementations, the mixed reality system 650 includes a headset only, without an external compute device or includes other wired or wireless connections between the mixed reality HMD 652 and the core processing component 654. The mixed reality HMD 652 includes a pass-through display 658 and a frame 660. The frame 660 can house various electronic components (not shown) such as light projectors (e.g., LASERs, LEDs, etc.), cameras, eye-tracking sensors, MEMS components, networking components, etc.

The projectors can be coupled to the pass-through display 658, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 654 via link 656 to HMD 652. Controllers in the HMD 652 can convert the image data into light pulses from the projectors, which can be transmitted via the optical elements as output light to the user's eye. The output light can mix with light that passes through the display 658, allowing the output light to present virtual objects that appear as if they exist in the real world.

Similarly to the HMD 600, the HMD system 650 can also include motion and position tracking units, cameras, light sources, etc., which allow the HMD system 650 to, e.g., track itself in 3DoF or 6DoF, track portions of the user (e.g., hands, feet, head, or other body parts), map virtual objects to appear as stationary as the HMD 652 moves, and have virtual objects react to gestures and other real-world objects.

FIG. 6C illustrates controllers 670 (including controller 676A and 676B), which, in some implementations, a user can hold in one or both hands to interact with an artificial reality environment presented by the HMD 600 and/or HMD 650. The controllers 670 can be in communication with the HMDs, either directly or via an external device (e.g., core processing component 654). The controllers can have their own IMU units, position sensors, and/or can emit further light points. The HMD 600 or 650, external sensors, or sensors in the controllers can track these controller light points to determine the controller positions and/or orientations (e.g., to track the controllers in 3DoF or 6DoF). The compute units 630 in the HMD 600 or the core processing component 654 can use this tracking, in combination with IMU and position output, to monitor hand positions and motions of the user. The controllers can also include various buttons (e.g., buttons 672A-F) and/or joysticks (e.g., joysticks 676A-B), which a user can actuate to provide input and interact with objects.

In various implementations, the HMD 600 or 650 can also include additional subsystems, such as an eye tracking unit, an audio system, various network components, etc., to monitor indications of user interactions and intentions. For example, in some implementations, instead of or in addition to controllers, one or more cameras included in the HMD 600 or 650, or from external cameras, can monitor the positions and poses of the user's hands to determine gestures and other hand and body motions. As another example, one or more light sources can illuminate either or both of the user's eyes and the HMD 600 or 650 can use eye-facing cameras to capture a reflection of this light to determine eye position (e.g., based on set of reflections around the user's cornea), modeling the user's eye and determining a gaze direction.

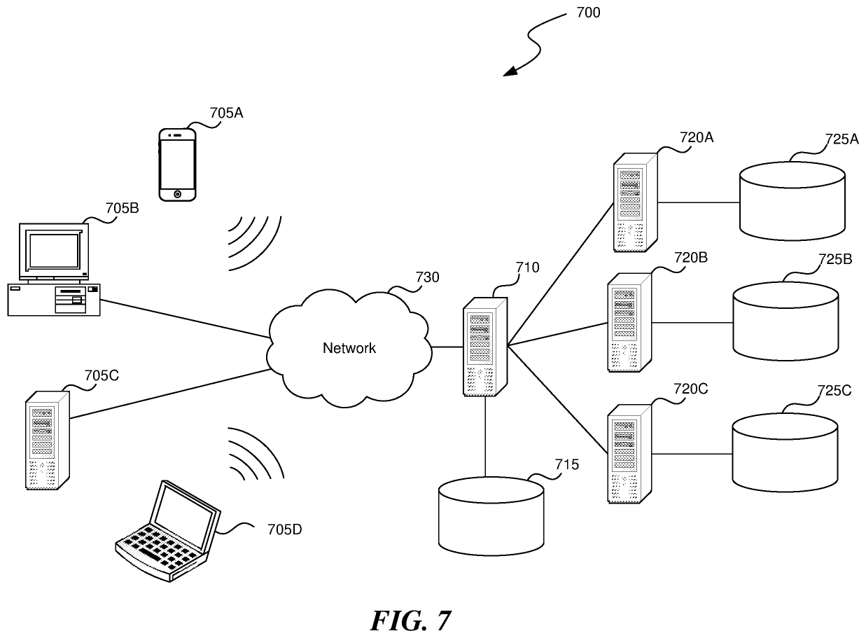

FIG. 7 is a block diagram illustrating an overview of an environment 700 in which some implementations of the disclosed technology can operate. Environment 700 can include one or more client computing devices 705A-D, examples of which can include device 500. Client computing devices 705 can operate in a networked environment using logical connections through network 730 to one or more remote computers, such as a server computing device.

In some implementations, server 710 can be an edge server which receives client requests and coordinates fulfillment of those requests through other servers, such as servers 720A-C. Server computing devices 710 and 720 can comprise computing systems, such as device 500. Though each server computing device 710 and 720 is displayed logically as a single server, server computing devices can each be a distributed computing environment encompassing multiple computing devices located at the same or at geographically disparate physical locations. In some implementations, each server 720 corresponds to a group of servers.

Client computing devices 705 and server computing devices 710 and 720 can each act as a server or client to other server/client devices. Server 710 can connect to a database 715. Servers 720A-C can each connect to a corresponding database 725A-C. As discussed above, each server 720 can correspond to a group of servers, and each of these servers can share a database or can have their own database. Databases 715 and 725 can warehouse (e.g., store) information. Though databases 715 and 725 are displayed logically as single units, databases 715 and 725 can each be a distributed computing environment encompassing multiple computing devices, can be located within their corresponding server, or can be located at the same or at geographically disparate physical locations.

Network 730 can be a local area network (LAN) or a wide area network (WAN), but can also be other wired or wireless networks. Network 730 may be the Internet or some other public or private network. Client computing devices 705 can be connected to network 730 through a network interface, such as by wired or wireless communication. While the connections between server 710 and servers 720 are shown as separate connections, these connections can be any kind of local, wide area, wired, or wireless network, including network 730 or a separate public or private network.

Embodiments of the disclosed technology may include or be implemented in conjunction with an artificial reality system. Artificial reality or extra reality (XR) is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers.

“Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof. Additional details on XR systems with which the disclosed technology can be used are provided in U.S. patent application Ser. No. 17/170,839, titled “INTEGRATING ARTIFICIAL REALITY AND OTHER COMPUTING DEVICES,” filed Feb. 8, 2021, which is herein incorporated by reference.

Those skilled in the art will appreciate that the components and blocks illustrated above may be altered in a variety of ways. For example, the order of the logic may be rearranged, substeps may be performed in parallel, illustrated logic may be omitted, other logic may be included, etc. As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc. Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for generating a build record in a first artificial reality (XR) system, the method comprising:
capturing an action performed by a creator within a first XR environment;
determining that the action is a recordable action based on the action affecting one or more properties of an object within the first XR environment;
recording a data sub-record representative of the captured action;
generating, based at least in part on the data sub-record and one or more other data sub-records, a build record representing one or more recordable actions performed by the creator when creating the object within the first XR environment; and
transmitting a copy of the build record to a server;
wherein the build record is played back on a second XR system by:
retrieving the build record, representing one or more recorded actions performed by the creator and including one or more sub-records including the data sub-record; and
for each sub-record in the build record, causing an avatar in a second XR environment different from the first XR environment to perform the action represented by the sub-record.

2. The method of claim 1, wherein the data sub-record includes an audio recording and/or a written annotation, from the creator, which is provided when the avatar in the second XR environment performs the corresponding action for the data sub-record.

3. The method of claim 1, wherein the build record comprises a series of instructions, stored as a JSON or XML data structure, the can be executed to create an instance of the object.

4. The method of claim 1,
wherein the creator sets an element of captured action, that the data sub-record is representative of, as modifiable based on a provided parameter,
wherein a second user other than the creator provides the parameter to customize the performance of the action, for the second XR environment, in terms of one or more of selecting a particular style, linking to a specific URL or blockchain address, selecting a color, selecting a material, or any combination thereof, and
wherein the second user provides the parameter through a menu specifying options for the action.

5. The method of claim 1, wherein the creator sets an element of captured action, that the data sub-record is representative of, as modifiable based on a provided parameter, wherein a second user other than the creator provides the parameter to customize the performance of the action, for the second XR environment, in terms of one or more of selecting a particular style, linking to a specific URL or blockchain address, selecting a color, selecting a material, or any combination thereof.

6. The method of claim 1, wherein the creator sets an element of captured action, that the data sub-record is representative of, as modifiable based on a provided parameter, and wherein a second user other than the creator provides the parameter to customize the performance of the action for the second XR environment.

7. The method of claim 1, wherein the performing the action, in the second artificial reality environment, represented by the sub-record includes providing in the second artificial reality environment playback tools to control the play back of the one or more recorded actions, the playback tools including a tool to control a playback speed, a tool to pause playback, and a tool to jump backwards or forwards in the one or more recorded actions.

8. A computer-readable storage medium storing instructions that, when executed by a computing system, cause the computing system to perform a process for generating a build record in a first artificial reality (XR) system, the process comprising:
capturing an action performed by a creator within a first XR environment;
determining that the action is a recordable action based on the action affecting one or more properties of an object within the first XR environment;
recording a data sub-record representative of the captured action;
generating, based at least in part on the data sub-record and one or more other data sub-records, a build record representing one or more recordable actions performed by the creator when creating the object within the first XR environment; and
transmitting a copy of the build record to a server;
wherein the build record is played back on a second XR system by:
retrieving the build record, representing one or more recorded actions performed by the creator and including one or more sub-records including the data sub-record; and
for each sub-record in the build record, causing performance, in a second XR environment different from the first XR environment, of the action represented by the sub-record.

9. The computer-readable storage medium of claim 8, wherein the data sub-record includes an audio recording and/or a written annotation, from the creator, which is provided when the action for the data sub-record is performed in the second XR environment.

10. The computer-readable storage medium of claim 8, wherein the build record comprises a series of instructions, stored as a JSON or XML data structure, the can be executed to create an instance of the object.

11. The computer-readable storage medium of claim 8,
wherein the creator sets an element of captured action, that the data sub-record is representative of, as modifiable based on a provided parameter,
wherein a second user other than the creator provides the parameter to customize the performance of the action, for the second XR environment, in terms of one or more of selecting a particular style, linking to a specific URL or blockchain address, selecting a color, selecting a material, or any combination thereof, and
wherein the second user provides the parameter through a menu specifying options for the action.

12. The computer-readable storage medium of claim 8, wherein the creator sets an element of captured action, that the data sub-record is representative of, as modifiable based on a provided parameter, wherein a second user other than the creator provides the parameter to customize the performance of the action, for the second XR environment, in terms of one or more of selecting a particular style, linking to a specific URL or blockchain address, selecting a color, selecting a material, or any combination thereof.

13. The computer-readable storage medium of claim 8, wherein the creator sets an element of captured action, that the data sub-record is representative of, as modifiable based on a provided parameter, and wherein a second user other than the creator provides the parameter to customize the performance of the action for the second XR environment.

14. The computer-readable storage medium of claim 8, wherein the performing the action, in the second artificial reality environment, represented by the sub-record includes providing in the second artificial reality environment playback tools to control the play back of the one or more recorded actions, the playback tools including a tool to control a playback speed, a tool to pause playback, and a tool to jump backwards or forwards in the one or more recorded actions.

15. A computing system for generating a build record in a first artificial reality (XR) system, the computing system comprising:
one or more processors; and
one or more memories storing instructions that, when executed by the one or more processors, cause the computing system to perform a process comprising:
capturing an action performed by a creator within a first XR environment;
determining that the action is a recordable action based on the action affecting one or more properties of an object within the first XR environment;
recording a data sub-record representative of the captured action;
generating, based at least in part on the data sub-record and one or more other data sub-records, a build record representing one or more recordable actions performed by the creator when creating the object within the first XR environment; and
transmitting a copy of the build record to a server;
wherein the build record is played back on a second XR system by:
retrieving the build record, representing one or more recorded actions performed by the creator and including one or more sub-records including the data sub-record; and
for each sub-record in the build record, causing performance, in a second XR environment different from the first XR environment, of the action represented by the sub-record.

16. The computing system of claim 15, wherein the data sub-record includes an audio recording and/or a written annotation, from the creator, which is provided when the action for the data sub-record is performed in the second XR environment.

17. The computing system of claim 15, wherein the build record comprises a series of instructions, stored as a JSON or XML data structure, the can be executed to create an instance of the object.

18. The computing system of claim 15,
wherein the creator sets an element of captured action, that the data sub-record is representative of, as modifiable based on a provided parameter,
wherein a second user other than the creator provides the parameter to customize the performance of the action, for the second XR environment, in terms of one or more of selecting a particular style, linking to a specific URL or blockchain address, selecting a color, selecting a material, or any combination thereof, and
wherein the second user provides the parameter through a menu specifying options for the action.

19. The computing system of claim 15, wherein the creator sets an element of captured action, that the data sub-record is representative of, as modifiable based on a provided parameter, wherein a second user other than the creator provides the parameter to customize the performance of the action, for the second XR environment, in terms of one or more of selecting a particular style, linking to a specific URL or blockchain address, selecting a color, selecting a material, or any combination thereof.

20. The computing system of claim 15, wherein the creator sets an element of captured action, that the data sub-record is representative of, as modifiable based on a provided parameter, and wherein a second user other than the creator provides the parameter to customize the performance of the action for the second XR environment.
